(19) United States
(12) Patent Application Publication
(10) Pub. No.: US 2025/0187462 A1
(43) Pub. Date: Jun. 12, 2025

(54) HINGE ASSEMBLY FOR VEHICLE CHARGE PORT DOOR

(71) Applicant: GM Global Technology Operations LLC, Detroit, MI (US)

(72) Inventors: Junghoon Kim, Yangcheon-gu (KR); Jongseok Yoon, Seodaemun-gu (KR)

(21) Appl. No.: 18/532,192

(22) Filed: Dec. 7, 2023

(51) Int. Cl. E05D 7/06; B60L 53/14; E05D 3/10; E05D 5/06

(52) U.S. Cl. CPC B60L 53/14; B60K 2015/053; E05D 2005/067; E05Y 2900/534

(57) ABSTRACT

A vehicle charge port door assembly includes a door support structure and a hinge structure comprising a primary hinge rotatable about a first axis. The door support structure includes a first attachment structure, and the hinge structure comprises a second attachment structure. The first attachment structure and the second attachment structure form a secondary hinge assembly in which the first attachment structure is selectively rotatable with respect to the second attachment structure about a second axis that extends in a different direction from the first axis.

### INTRODUCTION

The subject disclosure relates to vehicles, and in particular to a charge port door for an electric vehicle.

### SUMMARY

In one exemplary embodiment, a vehicle charge port door assembly includes a door support structure and a hinge structure comprising a primary hinge rotatable about a first axis. The door support structure includes a first attachment structure. The hinge structure includes a second attachment structure. The first attachment structure and the second attachment structure form a secondary hinge assembly in which the first attachment structure is selectively rotatable with respect to the second attachment structure about a second axis that extends in a different direction from the first axis.

In addition to one or more of the features described herein, the second axis is perpendicular to the first axis.

In addition to one or more of the features described herein, the secondary hinge assembly has a first position in which the door support structure is unfolded and a second position in which the door support structure is folded. The first attachment structure is selectively rotatable with respect to the second attachment structure about the second axis from the first position to the second position.

In addition to one or more of the features described herein, the first attachment structure is configured to be lifted away from the second attachment structure to rotate the first attachment structure with respect to the second attachment structure between the first position and the second position.

In addition to one or more of the features described herein, the first attachment structure includes a first protrusion and the second attachment structure includes a first recess and a second recess. The first protrusion slots into the first recess in the first position and the first protrusion slots into the second recess in the second position.

In addition to one or more of the features described herein, the second attachment structure includes a stopper protrusion adjacent to the first recess that is configured to prevent the first protrusion of the first attachment structure from moving in a direction towards the stopper protrusion from the first position.

In addition to one or more of the features described herein, the secondary hinge assembly includes an elastic structure that biases the first attachment structure towards the second attachment structure when the first attachment structure is lifted away from the second attachment structure.

In addition to one or more of the features described herein, the first attachment structure includes an outer body that defines a cylindrical space therein and a lateral wall having an opening formed therein. The second attachment structure includes an inner cylindrical body that passes through the opening and extends at least partially into the cylindrical space.

In addition to one or more of the features described herein, the elastic structure is disposed around the inner cylindrical body within the cylindrical space.

In addition to one or more of the features described herein, the first attachment structure includes a second protrusion. The second attachment structure includes a third recess and a fourth recess, and the second protrusion slots into the third recess in the first position and the second protrusion slots into the fourth recess in the second position.

In addition to one or more of the features described herein, the stopper protrusion is adjacent to the fourth recess and is configured to prevent the second protrusion of the first attachment structure from moving in a direction towards the stopper protrusion from the second position.

In another exemplary embodiment, a vehicle includes a side mirror and a vehicle charge port door assembly comprising a charge port door cover, a door support structure, and a hinge structure comprising a primary hinge rotatable about a first axis. The door support structure includes a first attachment structure, and the hinge structure includes a second attachment structure. The first attachment structure and the second attachment structure form a secondary hinge assembly in which the first attachment structure is selectively rotatable with respect to the second attachment structure about a second axis that extends in a different direction from the first axis.

In addition to one or more of the features described herein, the secondary hinge assembly has a first position in which the door support structure is unfolded and a second position in which the door support structure is folded, and the first attachment structure is selectively rotatable with respect to the second attachment structure about the second axis from the first position to the second position.

In addition to one or more of the features described herein, in the first position, the charge port door cover extends outward from the vehicle farther than the side mirror, and in the second position, the charge port door cover extends outward from the vehicle a distance corresponding to or less than the side mirror.

In addition to one or more of the features described herein, the first attachment structure is configured to be lifted away from the second attachment structure to rotate the first attachment structure with respect to the second attachment structure between the first position and the second position.

In addition to one or more of the features described herein, the first attachment structure includes a first protrusion, the second attachment structure includes a first recess and a second recess, and the first protrusion slots into the first recess in the first position and the first protrusion slots into the second recess in the second position.

In addition to one or more of the features described herein, the second attachment structure includes a stopper protrusion adjacent to the first recess that is configured to prevent the first protrusion of the first attachment structure from moving in a direction towards the stopper protrusion from the first position.

In addition to one or more of the features described herein, the first attachment structure includes a second protrusion, the second attachment structure includes a third recess and a fourth recess, and the second protrusion slots into the third recess in the first position and the second protrusion slots into the fourth recess in the second position.

In addition to one or more of the features described herein, the stopper protrusion is adjacent to the fourth recess and is configured to prevent the second protrusion of the first attachment structure from moving in a direction towards the stopper protrusion from the second position.

In yet another exemplary embodiment, a vehicle includes a side mirror and a vehicle charge port door assembly comprising a charge port door cover, a door support structure, and a hinge structure comprising a primary hinge rotatable about a first axis. The door support structure includes a first attachment structure. The hinge structure includes a second attachment structure. The first attachment structure and the second attachment structure form a secondary hinge assembly in which the first attachment structure is selectively rotatable with respect to the second attachment structure about a second axis that extends perpendicular to the first axis. The secondary hinge assembly has a first position in which the door support structure is unfolded and a second position in which the door support structure is folded. The first attachment structure is selectively rotatable with respect to the second attachment structure about the second axis from the first position to the second position. In the first position, the charge port door cover extends outward from the vehicle farther than the side mirror. In the second position, the charge port door cover extends outward from the vehicle a distance corresponding to or less than the side mirror. The first attachment structure includes a first protrusion and a second protrusion. The second attachment structure includes a first recess, a second recess, a third recess, a fourth recess, and a stopper protrusion adjacent to the first recess and the fourth recess. The first protrusion slots into the first recess and the second protrusion slots into the third recess in the first position. The first protrusion slots into the second recess and the second protrusion slots into the fourth recess in the second position. The stopper protrusion is configured to prevent the first protrusion of the first attachment structure from moving in a direction towards the stopper protrusion from the first position, and to prevent the second protrusion of the first attachment structure from moving in a direction towards the stopper protrusion from the second position. The first attachment structure includes an outer body that defines a cylindrical space therein and a lateral wall having an opening formed therein. The second attachment structure includes an inner cylindrical body that passes through the opening and extends at least partially into the cylindrical space. The secondary hinge assembly includes an elastic structure around the inner cylindrical body within the cylindrical space that biases the first attachment structure towards the second attachment structure when the first attachment structure is lifted away from the second attachment structure.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a is a left side view of a vehicle including a battery pack assembly having a battery pack drain assembly according to a non-limiting example;

FIG. 2 is a front view of a side mirror and a charge port door assembly in a first position according to a non-limiting example;

FIG. 3 is a rear perspective view of a side mirror and a charge port door assembly in a first position according to a non-limiting example;

FIG. 4 is a front view of a side mirror and a charge port door assembly in a second position according to a non-limiting example;

FIG. 5 is a rear perspective view of a side mirror and a charge port door assembly in a second position according to a non-limiting example;

FIG. 6 is a front view of a charge port door assembly without a charge port door cover according to a non-limiting example;

FIG. 7 is a rear view of a charge port door assembly without a charge port door cover according to a non-limiting example;

FIG. 8 is a top view of a charge port door assembly without a charge port door cover according to a non-limiting example;

FIG. 9 is a bottom view of a charge port door assembly without a charge port door cover according to a non-limiting example;

FIG. 10 is a top view of a secondary hinge assembly according to a non-limiting example;

FIG. 11 is a top view of the secondary hinge assembly of FIG. 10 without a fastener;

FIG. 12 is a top perspective view of an inner attachment structure according to a non-limiting example;

FIG. 13 is a top view of the secondary hinge assembly of FIG. 11 without a elastic structure;

FIG. 14 is a cross-sectional view taken at line 14-14 of the secondary hinge assembly of FIG. 13;

FIG. 15 is a top view of an inner attachment structure according to a non-limiting example;

FIG. 16 is a cross-sectional view taken at line 16-16 of the inner attachment structure of FIG. 15;

FIG. 17 is a cross-sectional view taken at line 17-17 of the inner attachment structure of FIG. 15;

FIG. 18 is a top view of an outer attachment structure according to a non-limiting example;

FIG. 19 is a cross-sectional view taken at line 19-19 of the outer attachment structure of FIG. 18;

FIG. 20 is a cross-sectional view taken at line 20-20 of the outer attachment structure of FIG. 18;

FIG. 21 is a cross-sectional view of the secondary hinge assembly in the first position taken at 21-21 in FIG. 10;

FIG. 22 is a cross-sectional view of the secondary hinge assembly of FIG. 21 with the outer attachment structure lifted with respect to the inner attachment structure;

FIG. 23 is a cross-sectional view showing a first position of the secondary hinge assembly; and

FIG. 24 is a cross-sectional view showing a second position of the secondary hinge assembly.

### DETAILED DESCRIPTION

The following description is merely exemplary in nature and is not intended to limit the present disclosure, its application or uses. It should be understood that throughout the drawings, corresponding reference numerals indicate like or corresponding parts and features.

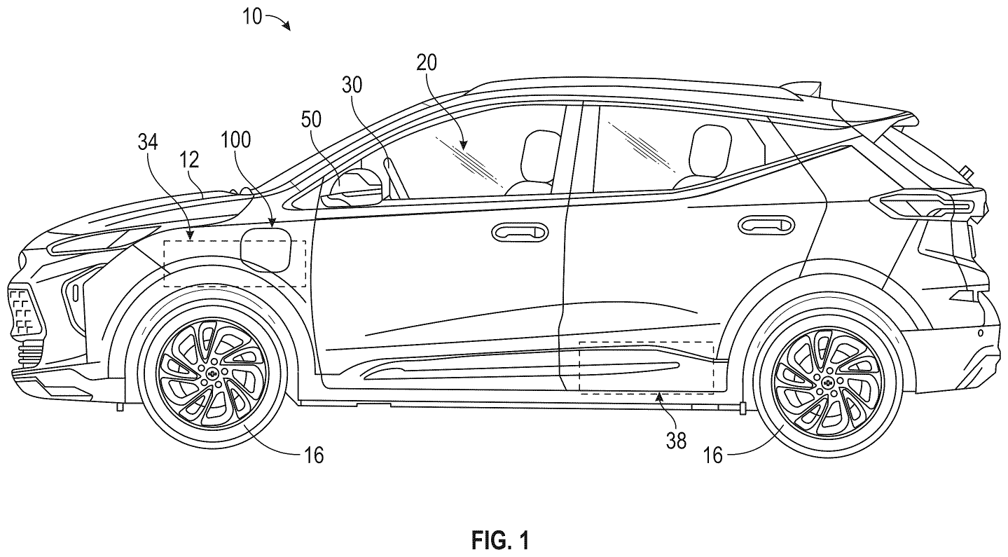

A vehicle 10 according to a non-limiting example is shown in FIG. 1. The vehicle 10 includes a body 12 supported on a plurality of wheels 16. One or more of the plurality of wheels 16 are steerable. The body 12 defines, in part, a passenger compartment 20. A steering control 30 is arranged in the passenger compartment 20 and is operated to control orientation of the wheels 16.

The vehicle 10 includes an electric motor 34 connected to a transmission (not shown) that provides power to one or more of the plurality of wheels 16. A rechargeable energy storage system 38 is arranged in the body 12 and provides power to the electric motor 34. Side mirrors 50 extend from lateral sides of the vehicle 10. A charge port door assembly 100 is disposed on a lateral surface of the body 12. In FIG. 1, the charge poor door assembly 100 is shown in a closed position. While specific locations are shown for the electric motor 34, the rechargeable energy storage system 38, the side mirrors 50, and the charge port door assembly 100 in FIG. 1, these locations are merely exemplary and not limiting, and locations of these structures may vary.

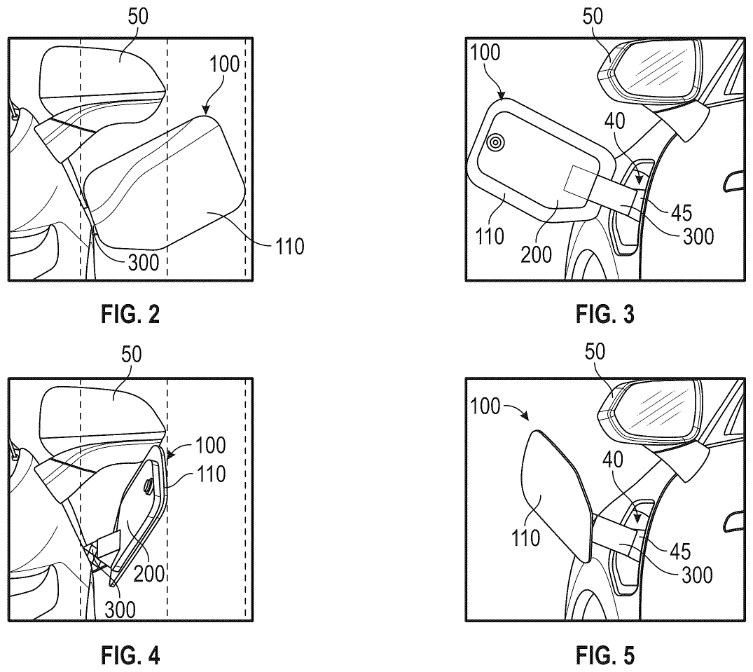

A non-limiting example of a side mirror 50 and a charge port door assembly 100 according to one or more embodiments are shown in FIGS. 2-5. Specifically, FIGS. 2-3 show front and rear perspective views, respectively, of the open charge port door assembly 100 according to one or more embodiments in a first position, and FIGS. 4-5 show front and rear perspective views, respectively, of the open charge port door assembly 100 according to one or more embodiments in a second position. According to one or more embodiments, the first position may be a normal open position and the second position may be a folded open position.

As shown in FIGS. 3 and 5, a charge port 40 is formed within a charge port frame 45 formed in the body 12 that is configured to receive a charging station connector to charge the rechargeable energy storage system 38. The charge port door assembly 100 is configured to open to provide access to the charge port 40. The charge port door assembly 100 may include a charge port door cover 110 disposed on a charge port door backing structure 200, and a charge port door hinge neck 300 having a first end attached to the charge port door backing structure 200 in a selectively rotatable manner, and a second end rotatably attached to a charge port frame 45. According to one or more embodiments, the charge port door backing structure 200 is an example of a door support structure, and the charge port door hinge neck 300 is an example of a hinge structure. As shown in FIGS. 2-3, in the first position, the charge port door hinge neck 300 is rotated outward about the charge port frame 45, while the charge port door backing structure 200 is unrotated with respect to the charge port door hinge neck 300. As shown in FIGS. 4-5, in the second position, the charge port door hinge neck 300 remains rotated outward about the charge port frame 45, while the charge port door backing structure 200 is rotated with respect to the charge port door hinge neck 300.

As shown in FIG. 2, when the charge port door assembly 100 is in the first position, the charge port door cover 110 may extend laterally farther than the side mirror 50. That is, when the charge port door assembly 100 is opened to provide access to the charge port 40, the charge port door cover 110 may increase a lateral profile of the vehicle 10. Thus, depending on the size of parking spots of the charging station, when the vehicle 10 is parked at the charging station, the increased lateral profile of the vehicle 10 may make it difficult or impossible for another vehicle to park in an adjacent spot. Additionally, the increased lateral profile of the vehicle 10 may result in the charge port door cover 110 being hit by another vehicle.

However, as shown in FIG. 4, when the charge port door assembly 100 is in the second position, the charge port door cover 110 may extend less laterally than in the first position. According to one or more embodiments, the charge port door cover 110 may extend to a lateral position corresponding to the side mirror 50. According to one or more embodiments, the charge port door cover 110 may extend laterally less than the side mirror 50. According to one or more embodiments, the charge port door cover 110 may extend laterally slightly more than the side mirror 50.

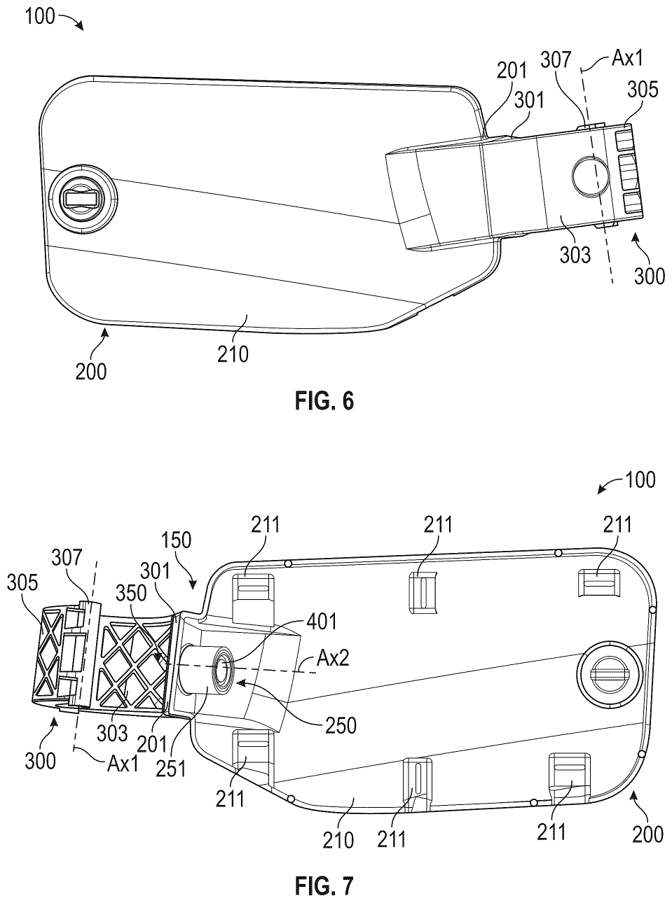

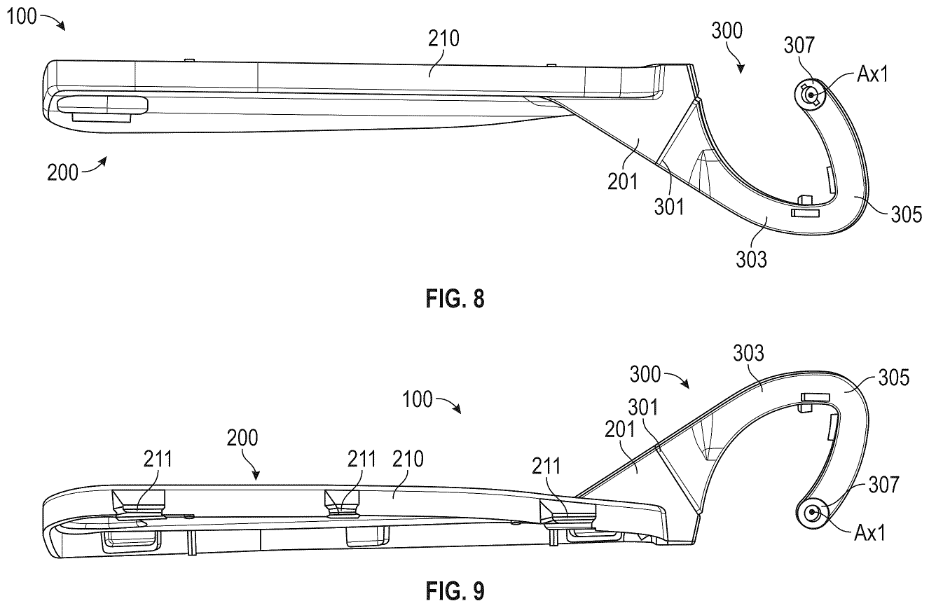

FIGS. 6-9 show front, rear, top, and bottom views, respectively, of the charge port door assembly 100 without the charge port door cover 110 according to one or more embodiments. The directions referenced with respect to FIGS. 6-9 are directions with respect to the charge port door assembly 100. The charge port door assembly 100 may include a charge port door backing structure 200 and a charge port door hinge neck 300.

According to one or more embodiments, the charge port door backing structure 200 may include a main body 210, having a plurality of fastening structures 211, that is configured to attach the main body 210 to a charge port door cover 110. While FIG. 7 shows six fastening structures 211, the present disclosure is not limited thereto, and may include more or less than six fastening structures 211. The charge port door backing structure 200 may further include a first abutment plate 201 that abuts a second abutment plate 301 of the charge port door hinge neck 300. The charge port door backing structure 200 may further include an outer attachment structure 250 configured to attach to an inner attachment structure 350 of the charge port door hinge neck 300 in a selectively rotatable manner about a second axis Ax2.

According to one or more embodiments, the outer attachment structure 250 may be an example of a first attachment structure and the inner attachment structure 350 may be an example of a second attachment structure. The outer attachment structure 250 may include an outer body 251. A fastener 401, which will be described below, is disposed within the outer body 251. According to one or more embodiments, the charge port door hinge neck 300 may include a second abutment plate 301, a neck main body 303, an elbow 305, and a primary hinge 307. The second abutment plate 301 abuts the first abutment plate 201. The neck main body 303 extends from the second abutment plate 301 to the elbow 305. The elbow 305 may be a U-shaped portion extending from the neck main body 303 to the primary hinge 307. The primary hinge 307 is a cylindrical structure defining a first axis Ax1 therethrough. The primary hinge 307 is structured to receive a corresponding shaft (not shown) disposed on the charge port frame 45 such that the primary hinge 307 is rotatable with respect to the charge port frame 45 about the first axis Ax1 from the closed position shown in FIG. 1 to the first position shown in FIG. 2-3. According to one or more embodiments, the charge port door hinge neck 300 may further include an inner attachment structure 350 disposed within the outer attachment structure 250 of the charge port door backing structure 200. The outer attachment structure 250, the inner attachment structure 350, the fastener 401 (see FIG. 11), and an elastic structure 403 may be collectively referred to as a secondary hinge assembly 150.

According to one or more embodiments, the first axis Ax1 and the second axis Ax2 extend in different directions. According to one or more embodiments, the first axis Ax1 extends in a perpendicular direction with respect to the second axis Ax2.

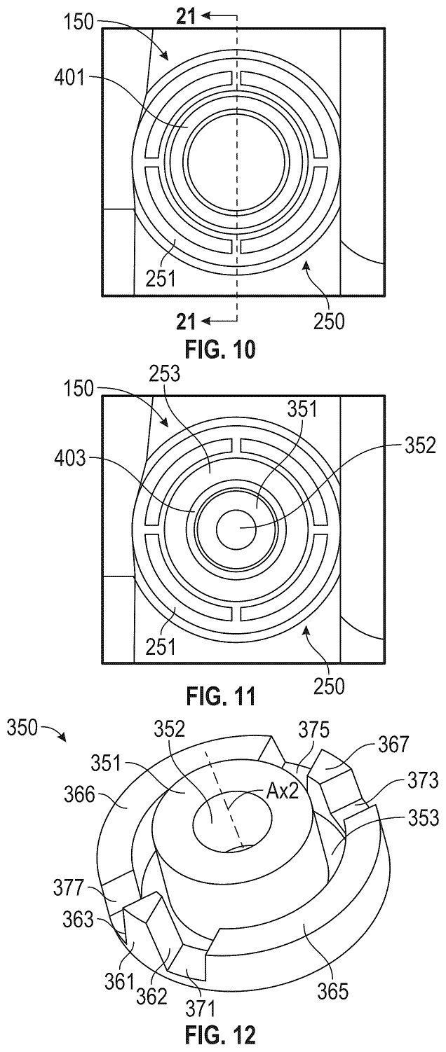

The directions referenced below with respect to FIGS. 10-24 are recited with respect to secondary hinge assembly 150 with the outer attachment structure 250 above the inner attachment structure 350 for ease of explanation. However, it will be appreciated that, as shown in FIGS. 2-5 and FIG. 7, the outer attachment structure 250 and the inner attachment structure 350 are adjacent to each other in a mostly lateral direction of the vehicle 10.

FIG. 10 shows a top view of a secondary hinge assembly 150 according to one or more embodiments. The secondary hinge assembly 150 may include the outer attachment structure 250 having an outer body 251 that surrounds a fastener 401. FIG. 11 shows the secondary hinge assembly 150 of FIG. 10 without the fastener 401. As shown in FIG. 11, under the fastener 401 is a first cylindrical space 253 into which an inner cylindrical body 351 of inner attachment structure 350 extends from below. The inner cylindrical body 351 surrounds an inner space 352 which receives the fastener 401. An elastic structure 403 is disposed in the first cylindrical space 253 on an outer surface of the inner cylindrical body 351. According to one or more embodiments, the elastic structure 403 may be a compression spring. According to one or more embodiments, the elastic structure 403 may be another structure known in the art configured to induce an upward force when the fastener 401 is pressed downward on the elastic structure 403.

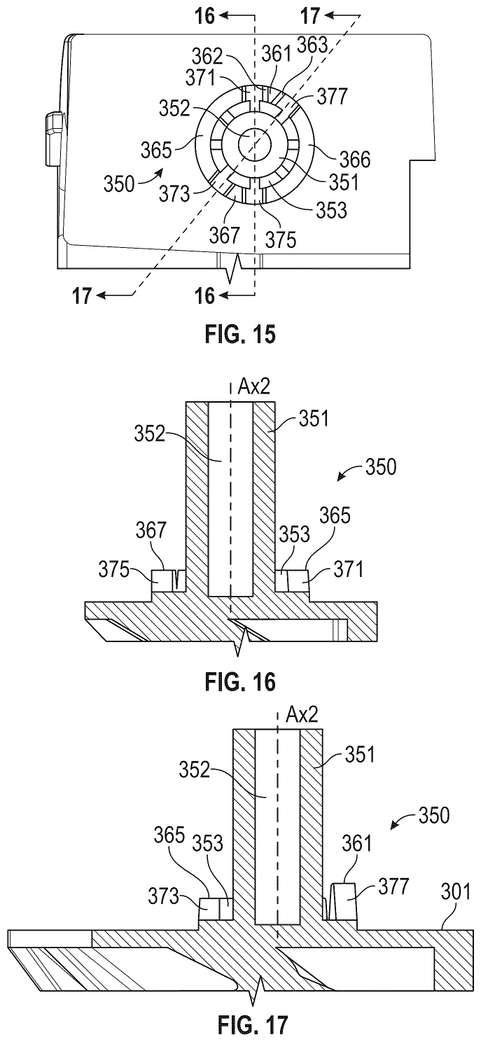

FIG. 12 shows a top perspective view of the inner attachment structure 350 according to one or more embodiments. FIG. 15 shows a top view of the inner attachment structure 350 according to one or more embodiments. FIG. 16 shows a cross-sectional view of the inner attachment structure 350 taken at line 16-16 in FIG. 15, and FIG. 17 shows a cross-sectional view of the inner attachment structure 350 taken at line 17-17 in FIG. 15.

In an embodiment, the inner attachment structure 350 includes inner cylindrical body 351 defining inner space 352 therein. Second axis Ax2 is defined through a center of the inner cylindrical body 351. A stopper protrusion 361, a first wall segment 365, a short protrusion 367, and a second wall segment 366 are disposed around the inner cylindrical body 351, each of which is shorter than the inner cylindrical body 351. A first recess 371 is formed between the stopper protrusion 361 and the first wall segment 365, a second recess 373 is formed between the first wall segment 365 and the short protrusion 367, a third recess 375 is formed between the short protrusion 367 and the second wall segment 366, and a fourth recess 377 is formed between the second wall segment 366 and the stopper protrusion 361.

According to one or more embodiments, the stopper protrusion 361, first recess 371, the first wall segment 365, the second recess 373, the short protrusion 367, the third recess 375, the second wall segment 366, and the fourth recess 377 are substantially equidistant from the second axis Ax2. An annular channel 353 may be defined between the inner cylindrical body 351 and the stopper protrusion 361, the first wall segment 365, the short protrusion 367, and the second wall segment 366.

According to one or more embodiments, the stopper protrusion 361 is taller than the short protrusion 367 and may include a first stopper surface 362 and a second stopper surface 363 facing opposite directions. According to one or more embodiments, the short protrusion 367 may be taller than the first wall segment 365 and the second wall segment 366. According to one or more embodiments, the short protrusion 367 may have a height corresponding to that of the first wall segment 365 and the second wall segment 366.

According to one or more embodiments, the stopper protrusion 361 and the short protrusion 367 may be formed diametrically opposite each other with respect to the second axis Ax2. According to one or more embodiments, the first wall segment 365 and the second wall segment 366 may be formed diametrically opposite each other with respect to the second axis Ax2. According to one or more embodiments, the first recess 371 and the third recess 375 may be formed diametrically opposite each other with respect to the second axis Ax2. According to one or more embodiments, the second recess 373 and the fourth recess 377 may be formed diametrically opposite each other with respect to the second axis Ax2.

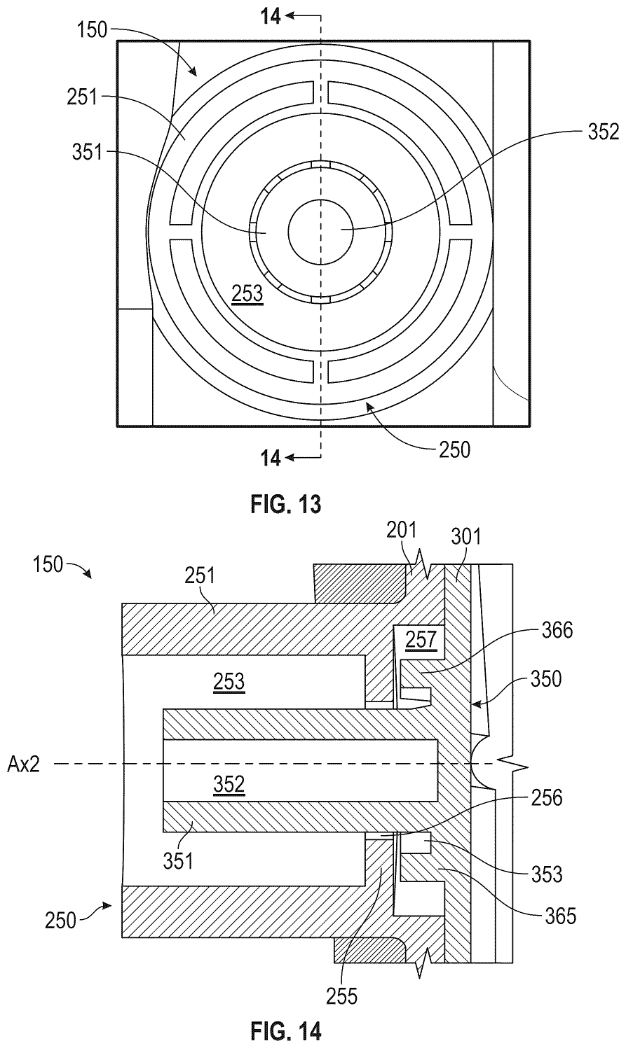

FIG. 13 shows the secondary hinge assembly 150 of FIG. 10 without the fastener 401 and the elastic structure 403, and FIG. 14 shows a cross-sectional view of the secondary hinge assembly 150 taken at 14-14 in FIG. 13. The inner cylindrical body 351 extends upward through an opening 256 formed in a lateral wall 255 of the outer attachment structure 250 and into the first cylindrical space 253 defined within the outer body 251.

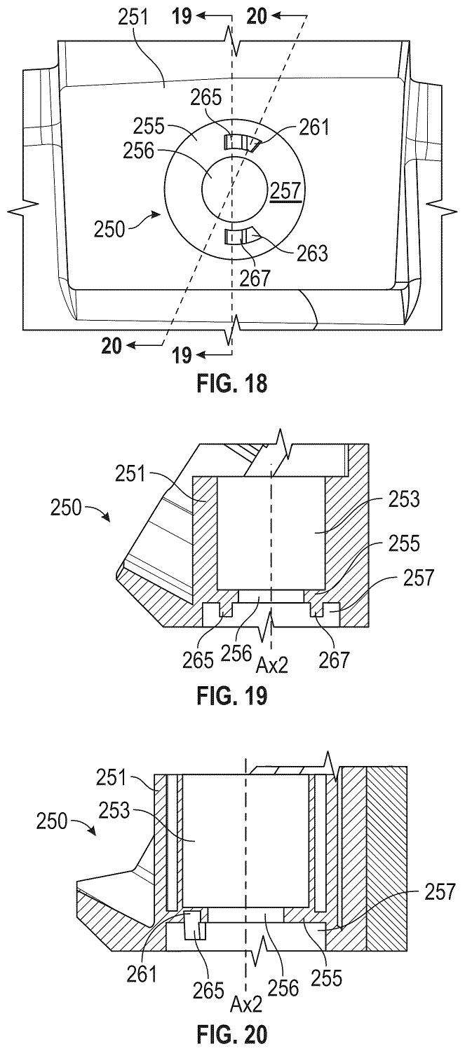

FIG. 18 shows a bottom view of the outer attachment structure 250 according to one or more embodiments. FIG. 19 shows a cross-sectional view of the outer attachment structure 250 taken at line 19-19 in FIG. 18, and FIG. 20 shows a cross-sectional view of the outer attachment structure 250 taken at line 20-20 in FIG. 18.

According to one or more embodiments, the outer attachment structure 250 includes outer body 251 that defines first cylindrical space 253, lateral wall 255 with opening 256 formed therein below the first cylindrical space 253, and a second cylindrical space 257 disposed below the lateral wall 255. The second axis Ax2 extends through a center of each of the first cylindrical space 253, the opening 256, and the second cylindrical space 257. The opening 256 connects the first cylindrical space 253 and the second cylindrical space 257. The first cylindrical space 253 is open on an upper end thereof. According to one or more embodiments, a first protrusion 265 and a second protrusion 267 may extend downward from an underside of the lateral wall 255, and a first indentation 261 may be disposed adjacent to the first protrusion 265 and a second indentation 263 may be disposed adjacent to the second protrusion 267. According to one or more embodiments, the first protrusion 265 and the second protrusion 267 may be guide bosses. According to one or more embodiments, the first protrusion 265 and the second protrusion 267 may be disposed diametrically opposite each other with respect to the second axis Ax2. According to one or more embodiments, the first indentation 261 and the second indentation 263 are shaped to correspond to the stopper protrusion 361 and the short protrusion 367 of the inner attachment structure 350. According to one or more embodiments, the first indentation 261, the second indentation 263, the first protrusion 265, and the second protrusion 267 may be substantially equidistant from the second axis Ax2.

According to one or more embodiments, the first indentation 261, the second indentation 263, the first protrusion 265, the second protrusion 267, the stopper protrusion 361, first recess 371, the first wall segment 365, the second recess 373, the short protrusion 367, the third recess 375, the second wall segment 366, and the fourth recess 377 may be substantially equidistant from the second axis Ax2.

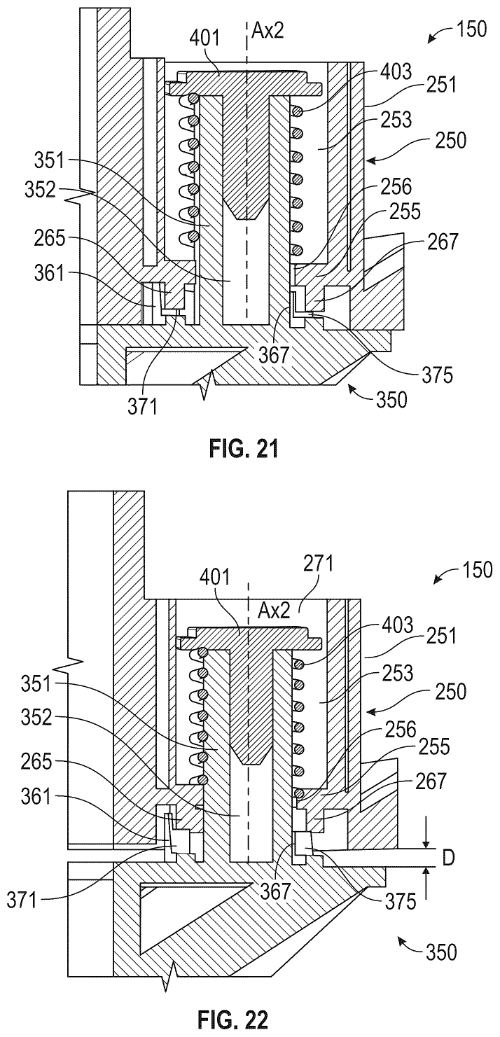

FIG. 21 shows a cross-sectional view of the secondary hinge assembly 150 in the first position taken at 21-21 in FIG. 10. According to one or more embodiments, a bottom portion of the fastener 401 is inserted into the inner space 352 of the inner cylindrical body 351. According to one or more embodiments, the fastener 401 may be a threaded bolt that engages with a threaded inner surface of the inner cylindrical body 351 to fasten to the inner cylindrical body 351. The elastic structure 403 may extend between a bottom surface of the top portion of the fastener 401 and a top surface of the lateral wall 255. In the first position of the secondary hinge assembly 150, the first protrusion 265 slots into the first recess 371, the second protrusion 267 slots into the third recess 375, and the stopper protrusion 361 slots into the first indentation 261. According to one or more embodiments, the short protrusion 367 may slot into the second indentation 263. According to one or more embodiments, the short protrusion 367 may float over the second indentation 263 without slotting thereinto.

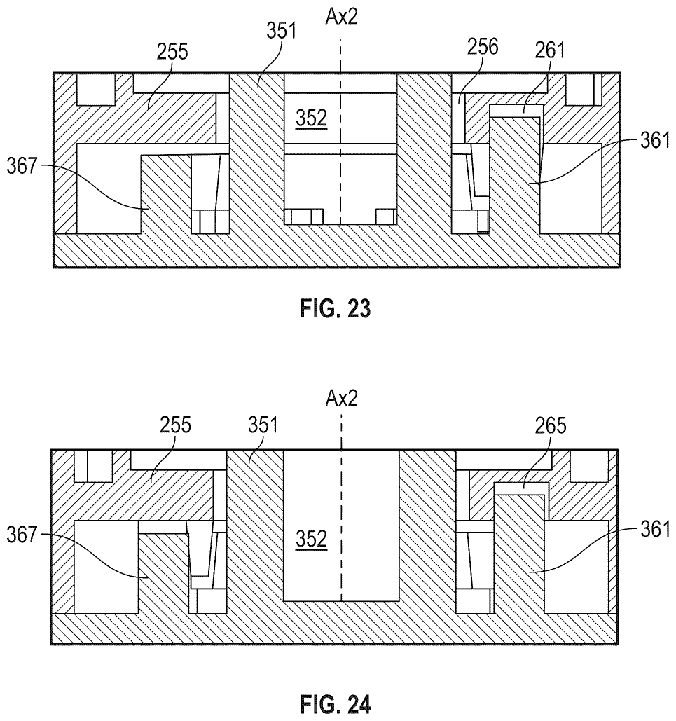

FIG. 22 shows a cross-sectional view of the secondary hinge assembly 150 shown in FIG. 21 with the outer attachment structure 250 lifted with respect to the inner attachment structure 350. FIG. 23 shows a cross-sectional view showing a first position of the secondary hinge assembly 150 in which the stopper protrusion 361 is slotted into the first indentation 261, and FIG. 24 shows a cross-sectional view showing a second position of the secondary hinge assembly 150 in which the stopper protrusion 361 is slotted into the second indentation 263.

Specifically, FIG. 22 shows the outer attachment structure 250 lifted a distance D with respect to the inner attachment structure 350. According to one or more embodiments, the distance D may correspond to or be greater than a height of the first wall segment 365 and the second wall segment 366 (see FIGS. 14-17) but less than a height of the stopper protrusion 361. Thus, a bottom end of the first protrusion 265 and the second protrusion 267 respectively clears the first wall segment 365 and the second wall segment 366 such that the outer attachment structure 250 may be rotated counterclockwise with respect to the inner attachment structure 350. As the distance D is less than a height of the stopper protrusion 361, the first protrusion 265 cannot clear the stopper protrusion 361 such that the outer attachment structure 250 may only be rotated with respect to the inner attachment structure 350 in a counterclockwise direction from the first position. Similarly, in the second position, the second protrusion 267 cannot clear the stopper protrusion 361 such that the outer attachment structure 250 may only be rotated with respect to the inner attachment structure 350 in a clockwise direction from the second position. That is, in the first position, the first protrusion 265 abuts the first stopper surface 362 (see FIG. 12) of the stopper protrusion 361 to prevent further rotation in the clockwise direction, and in the second position, the second protrusion 267 abuts the second stopper surface 363 (see FIG. 12) of the stopper protrusion 361 to prevent further rotation in the counterclockwise direction.

According to one or more embodiments, the elastic structure 403 has a radius larger than the opening 256 formed in the lateral wall 255 such that, as the outer attachment structure 250 is lifted with respect to the inner attachment structure 350, an upper surface of the lateral wall 255 abuts against a bottom of the elastic structure 403, compressing the elastic structure 403 against a bottom surface of an upper portion of the fastener 401. The compression of the elastic structure 403 induces a downward force on the outer attachment structure 250 to return the first protrusion 265 and the second protrusion 267 into the first recess 371 and the third recess 375 as shown in FIGS. 21 and 23 or, after rotating the outer attachment structure 250 with respect to the inner attachment structure 350, to slot the first protrusion 265 and the second protrusion 267 into the second recess 373 and the fourth recess 377. During rotation between the first and second positions, the first protrusion 265 slides over the first wall segment 365 and the second protrusion 267 slides over the second wall segment 366.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A vehicle charge port door assembly comprising:
a door support structure; and
a hinge structure comprising a primary hinge rotatable about a first axis,
wherein the door support structure comprises a first attachment structure,
wherein the hinge structure comprises a second attachment structure, and
wherein the first attachment structure and the second attachment structure form a secondary hinge assembly in which the first attachment structure is selectively rotatable with respect to the second attachment structure about a second axis that extends in a different direction from the first axis.

2. The vehicle charge port door assembly of claim 1, wherein the second axis is perpendicular to the first axis.

3. The vehicle charge port door assembly of claim 1,
wherein the secondary hinge assembly has a first position in which the door support structure is unfolded and a second position in which the door support structure is folded, and
wherein the first attachment structure is selectively rotatable with respect to the second attachment structure about the second axis from the first position to the second position.

4. The vehicle charge port door assembly of claim 3, wherein the first attachment structure is configured to be lifted away from the second attachment structure to rotate the first attachment structure with respect to the second attachment structure between the first position and the second position.

5. The vehicle charge port door assembly of claim 3,
wherein the first attachment structure comprises a first protrusion,
wherein the second attachment structure comprises a first recess and a second recess, and
wherein the first protrusion slots into the first recess in the first position and the first protrusion slots into the second recess in the second position.

6. The vehicle charge port door assembly of claim 5, wherein the second attachment structure comprises a stopper protrusion adjacent to the first recess that is configured to prevent the first protrusion of the first attachment structure from moving in a direction towards the stopper protrusion from the first position.

7. The vehicle charge port door assembly of claim 4, wherein the secondary hinge assembly comprises an elastic structure that biases the first attachment structure towards the second attachment structure when the first attachment structure is lifted away from the second attachment structure.

8. The vehicle charge port door assembly of claim 7,
wherein the first attachment structure comprises an outer body that defines a cylindrical space therein and a lateral wall having an opening formed therein, and
wherein the second attachment structure comprises an inner cylindrical body that passes through the opening and extends at least partially into the cylindrical space.

9. The vehicle charge port door assembly of claim 8, wherein the elastic structure is disposed around the inner cylindrical body within the cylindrical space.

10. The vehicle charge port door assembly of claim 6,
wherein the first attachment structure further comprises a second protrusion,
wherein the second attachment structure further comprises a third recess and a fourth recess, and
wherein the second protrusion slots into the third recess in the first position and the second protrusion slots into the fourth recess in the second position.

11. The vehicle charge port door assembly of claim 10, wherein the stopper protrusion is adjacent to the fourth recess and is configured to prevent the second protrusion of the first attachment structure from moving in a direction towards the stopper protrusion from the second position.

12. A vehicle comprising:
a side mirror; and
a vehicle charge port door assembly comprising:
a charge port door cover,
a door support structure, and
a hinge structure comprising a primary hinge rotatable about a first axis,
wherein the door support structure comprises a first attachment structure,
wherein the hinge structure comprises a second attachment structure, and
wherein the first attachment structure and the second attachment structure form a secondary hinge assembly in which the first attachment structure is selectively rotatable with respect to the second attachment structure about a second axis that extends in a different direction from the first axis.

13. The vehicle of claim 12,
wherein the secondary hinge assembly has a first position in which the door support structure is unfolded and a second position in which the door support structure is folded, and
wherein the first attachment structure is selectively rotatable with respect to the second attachment structure about the second axis from the first position to the second position.

14. The vehicle of claim 13,
wherein, in the first position, the charge port door cover extends outward from the vehicle farther than the side mirror, and
wherein, in the second position, the charge port door cover extends outward from the vehicle a distance corresponding to or less than the side mirror.

15. The vehicle of claim 13, wherein the first attachment structure is configured to be lifted away from the second attachment structure to rotate the first attachment structure with respect to the second attachment structure between the first position and the second position.

16. The vehicle of claim 13,
wherein the first attachment structure comprises a first protrusion,
wherein the second attachment structure comprises a first recess and a second recess, and
wherein the first protrusion slots into the first recess in the first position and the first protrusion slots into the second recess in the second position.

17. The vehicle of claim 16, wherein the second attachment structure comprises a stopper protrusion adjacent to the first recess that is configured to prevent the first protrusion of the first attachment structure from moving in a direction towards the stopper protrusion from the first position.

18. The vehicle of claim 17,
wherein the first attachment structure further comprises a second protrusion,
wherein the second attachment structure further comprises a third recess and a fourth recess, and
wherein the second protrusion slots into the third recess in the first position and the second protrusion slots into the fourth recess in the second position.

19. The vehicle of claim 18, wherein the stopper protrusion is adjacent to the fourth recess and is configured to prevent the second protrusion of the first attachment structure from moving in a direction towards the stopper protrusion from the second position.

20. A vehicle comprising:
a side mirror; and
a vehicle charge port door assembly comprising:
a charge port door cover,
a door support structure, and
a hinge structure comprising a primary hinge rotatable about a first axis,
wherein the door support structure comprises a first attachment structure,
wherein the hinge structure comprises a second attachment structure,
wherein the first attachment structure and the second attachment structure form a secondary hinge assembly in which the first attachment structure is selectively rotatable with respect to the second attachment structure about a second axis that extends perpendicular to the first axis,
wherein the secondary hinge assembly has a first position in which the door support structure is unfolded and a second position in which the door support structure is folded,
wherein the first attachment structure is selectively rotatable with respect to the second attachment structure about the second axis from the first position to the second position,
wherein, in the first position, the charge port door cover extends outward from the vehicle farther than the side mirror,
wherein, in the second position, the charge port door cover extends outward from the vehicle a distance corresponding to or less than the side mirror,
wherein the first attachment structure comprises a first protrusion and a second protrusion,
wherein the second attachment structure comprises a first recess, a second recess, a third recess, a fourth recess, and a stopper protrusion adjacent to the first recess and the fourth recess,
wherein the first protrusion slots into the first recess and the second protrusion slots into the third recess in the first position,
wherein the first protrusion slots into the second recess and the second protrusion slots into the fourth recess in the second position,
wherein the stopper protrusion is configured to prevent the first protrusion of the first attachment structure from moving in a direction towards the stopper protrusion from the first position, and to prevent the second protrusion of the first attachment structure from moving in a direction towards the stopper protrusion from the second position,
wherein the first attachment structure comprises an outer body that defines a cylindrical space therein and a lateral wall having an opening formed therein,
wherein the second attachment structure comprises an inner cylindrical body that passes through the opening and extends at least partially into the cylindrical space, and
wherein the secondary hinge assembly comprises an elastic structure around the inner cylindrical body within the cylindrical space that biases the first attachment structure towards the second attachment structure when the first attachment structure is lifted away from the second attachment structure.
